(19) United States
(12) Patent Application Publication
(10) Pub. No.: US 2021/0355045 A1
(43) Pub. Date: Nov. 18, 2021

(54) SMART COMPOSTING APPARATUS

(71) Applicants: Brad Morehead, Winnetka, IL (US); Jennifer Moore Morehead, Winnetka, IL (US); John Thomas Morehead, Winnetka, IL (US); Trent Roger Morehead, Winnetka, IL (US); Luke Edward Morehead, Winnetka, IL (US)

(72) Inventors: Brad Morehead, Winnetka, IL (US); Jennifer Moore Morehead, Winnetka, IL (US); John Thomas Morehead, Winnetka, IL (US); Trent Roger Morehead, Winnetka, IL (US); Luke Edward Morehead, Winnetka, IL (US)

(21) Appl. No.: 17/324,018

(22) Filed: May 18, 2021

Related U.S. Application Data
(60) Provisional application No. 63/026,686, filed on May 18, 2020.

(51) Int. Cl. C05F 17/70; C05F 9/02; H04L 12/28

(52) U.S. Cl. CPC C05F 17/70; H04L 12/2816; C05F 9/02

(57) ABSTRACT

A composting apparatus comprises a bin, an access panel, an aerator, a water content sensor, a valve, and a composting controller. The bin stores organic materials and compost therein. The access panel, disposed over an opening within the bin, allows access to an interior of the bin. The aerator, disposed within the bin, allows air into the bin to aerate the organic materials and compost therein. The water content sensor, disposed within the bin, senses a quantity of water within the organic materials and compost within the bin. The valve, coupled to a water line, controls a quantity of water added to the bin. The composting controller, coupled to the water content sensor and the water valve, actuates the water valve to control a quantity of water added to the bin based on the sensed quantity of water within the organic materials and compost.

### CROSS-REFERENCE TO RELATED APPLICATION

This application claims priority from U.S. Patent Application Ser. No. 63/026,686, filed May 18, 2020, entitled “SMART COMPOSTING APPARATUS”, the entire specification of which is hereby incorporated by reference in its entirety.

### BACKGROUND OF THE DISCLOSURE

### Field of the Disclosure

The disclosure relates in general to a composting apparatus, and more particularly, to a smart composting apparatus.

### Background Art

Composting has become a popular form of recycling in which organic materials, typically from a kitchen or yard, are decomposed to form organic matter or compost. This organic matter is then typically used as a soil condition or fertilizer. Compost is rich in nutrients, and can be used in, e.g., gardens, landscaping, horticulture, urban agriculture, organic farming, etc. Composting typically is a process by which wet organic matter, such as leaves, grass, and food scraps, are broken down over time into humus or compost, such as over a period of months.

With nearly everyone being stuck at home with the current pandemic, people are cooking more than ever. This increased cooking has produced large quantities of food waste that many people are dealing with. With people becoming more environmentally conscience about the planet and wanting to be more eco-friendly/green, Internet searches for composting are up 2×-4× at these times. Many typical composting apparatus are hobby items and/or are really confusing to operate. Some typical composting apparatus are just insulated plastic bins with an aeration pipe and reservoir/drain tube, while others are just a tube on a roller, or a rotating drum. The wet organic matter is typically placed into the rotating drum, requiring a user to periodically turn the drum to mix the organic matter and add water to the drum to keep the organic matter therein moist. Composting can also take place as a multi-step manual labor-intensive process, closely monitored with measured inputs of water, air, and carbon- and nitrogen-rich materials.

### SUMMARY OF THE DISCLOSURE

The disclosure is directed to a composting apparatus comprising a bin, an access panel, an aerator, a water content sensor, a valve, and a composting controller. The bin stores organic materials and compost therein. The access panel, disposed over an opening within the bin, allows access to an interior of the bin. The aerator, disposed within the bin, allows air into the bin to aerate the organic materials and compost therein. The water content sensor, disposed within the bin, senses a quantity of water within the organic materials and compost within the bin. The valve, coupled to a water line, controls a quantity of water added to the bin. The composting controller, coupled to the water content sensor and the water valve, actuates the water valve to control a quantity of water added to the bin based on the sensed quantity of water within the organic materials and compost.

In some configurations, the bin is a drum.

In some configurations, the composting apparatus further comprises a water valve, coupled to the composing controller, to control an amount of water that is added to the bin based on the quantity of moisture sensed within the organic materials and compost.

In some configurations, the composting apparatus further comprises a carbon filter to mitigate odors associated with the organic materials.

In some configurations, the composting apparatus further comprises at least one other sensor, coupled to the composing controller, the at least one other sensor being at least one of a pH sensor, a nitrogen sensor, a carbon sensor, an ammonia sensor, and an oxygen sensor that sense one of pH, nitrogen, carbon, ammonia, and oxygen, respectively, the composting controller adjusting to the composting process occurring within the bin based on the sensed at least one of pH, nitrogen, carbon, ammonia, and oxygen.

In some configurations, the composting apparatus further comprises a shredder and mulcher, coupled to the access penal, to shred and mulch the organic materials as the organic materials are being are being added to the bin.

In some configurations, the composting apparatus further comprises legs to elevate the bin off of a ground.

In some configurations, the legs are disposed on either sides of the bin and centrally to ends of the bin to allow the bin to rotate about where the legs are coupled to the bin.

In some configurations, the composting apparatus further comprises an actuator to periodically rotate the bin to mix the organic materials and compost therein.

In some configurations, the composting apparatus further comprises an agitator, disposed within the bin, coupled to an actuator, the actuator rotating the agitator to mix the organic materials and compost within the bin.

In some configurations, the agitator is at least one of a paddle, an auger, and a compost crank aerator.

In some configurations, the composting apparatus further comprises a combination actuator to periodically rotate the bin to mix the organic materials and compost within the bin and to rotate an agitator to mix the organic materials and compost within the bin.

In some configurations, the composting apparatus further comprises a temperature sensor, disposed within the bin, to sense a temperature within the bin, the composting controller further to activate an actuator when a temperature within the bin falls outside of 130-170 degrees F.

In some configurations, the composting apparatus further comprises a weight sensor to detect a weight of the organic materials and compost within the bin, with the water content sensor being a humidity sensor to detect a quantity of humidity within the bin, the composting controller formulating the water content of the organic materials and compost based on the detected humidity within the bin from the humidity sensor and based on the weight of the organic materials and compost from the weight sensor.

In some configurations, the water content sensor is a moisture sensor to detect a quantity of moisture within the organic materials and compost.

In some configurations, the aerator is at least one of an aeration pipe including a plurality of holes therethrough along a length of the aeration pipe and at least one aeration vent.

In some configurations, the moisture sensor is a dielectric permittivity sensor.

In some configurations, the aerator is at least one of an aeration pipe including a plurality of holes therethrough along a length of the aeration pipe and at least one aeration vent.

In some configurations, a system includes the composting apparatus, the system further comprising a wireless computing device to remotely control operation of the composting controller.

In some configurations, the wireless computing device includes directions for operating the smart composting apparatus.

### BRIEF DESCRIPTION OF THE DRAWINGS

The disclosure will now be described with reference to the drawings wherein:

FIG. 1 illustrates an example smart composting apparatus, in accordance with at least one embodiment disclosed herein; and

FIG. 2 illustrates an example schematic representation of a general-purpose computing device, a version of which may comprise a composting controller shown in FIG. 1, in accordance with at least one embodiment disclosed herein.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

To overcome the manual labor-intensive process and confusing nature of typical composting discussed above associated with typical composting apparatus, an apparatus is disclosed herein that automates a large portion of the composting process. It has become appreciated that users typically add organic material to a drum, but are inconsistent with maintenance of the composting process. For example, users can forget to add water to the organic material to keep the organic matter moist and/or can forget to turn the drum to mix the wet organic matter. Such inconsistent maintenance can result in extending the period of time required to produce compost. In some instances, users forgo composting altogether because of such extended periods of time.

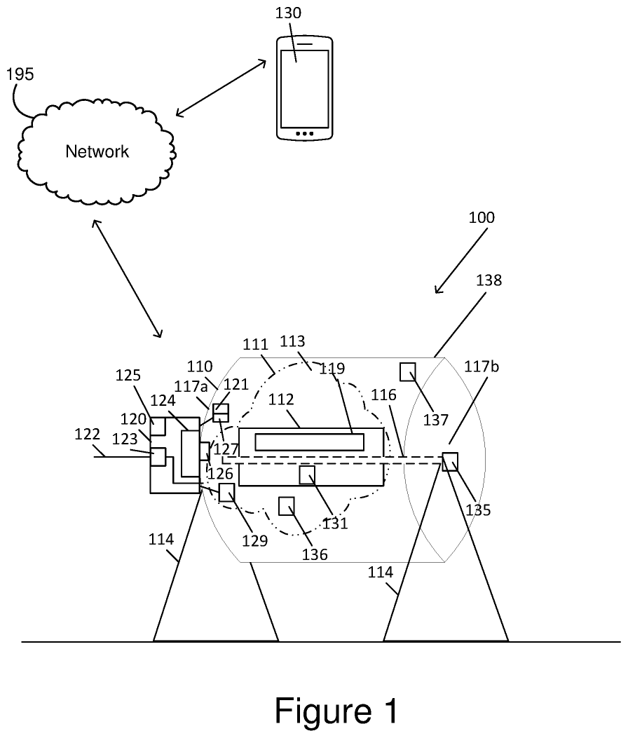

Referring now to the drawings and in particular to FIG. 1, an apparatus is discussed, such as a smart composting apparatus 100 that includes a bin 110, such as a drum, and an aerator 116, such as aeration pipe that includes a plurality of holes therethrough along a length of the aeration pipe (e.g., one-five aeration pipes (central and each corner) and reservoir/drain tube), disposed within the bin 110 to allow air into the bin 110 to aerate organic materials and compost 111 stored within the bin 110. Alternatively, or in conjunction with the aeration pipe, the aerator 115 can include at least one aeration vent 137 disposed within a housing 138 of the bin 110, the aeration vent 137 allowing air into the bin 110 to aerate organic materials and compost 111 stored within the bin 110.

Composting typically is best performed when moisture content of the organic materials and compost 111 is 40-60% by weight. To automatically optimize composting, the smart composting apparatus 100 automatically adjusts an amount of moisture content within the organic materials and compost 111. The smart composting apparatus 100 can further include a composting controller 120 that is coupled to a weight sensor 135 that detects a weight of the organic materials and compost 111 and the bin 110, with the composting controller 120 subtracting a weight of the bin 110 from the detected weight to determine weight of the organic materials and compost 111 within the bin 110.

The composting controller 120 is further coupled to a water content sensor that detects a quantity of water within the organic materials and compost 111, such as a humidity sensor 121 disposed within the bin 110 that detects a quantity of humidity within the bin 110. Humidity with the bin 110 is proportion to water content within the organic materials and compost 111, with the composting controller 120 formulating the water content of the organic materials and compost 111 based on the detected humidity within the bin 110 from the humidity sensor 121 and based on the weight of the organic materials and compost 111 from the weight sensor 135. Alternatively, or in conjunction with the humidity sensor 121, the composting controller 120 can be further coupled to a moisture sensor 136, such as a dielectric permittivity sensor. The moisture sensor 136 contacts the organic materials and compost 111 to sense water content of the organic materials and compost 111. In at least one embodiment, the composting controller 120 is coupled to and controls a water valve 123 that is coupled to a water line 122, such as a garden hose, a dedicated water pipe, or any other water line. The compositing controller 120 actuates the water valve 123 to control a quantity of water that is added to the bin 110 based on the quantity of moisture within the bin 110, such as within the organic materials and compost 111. Thus, the compositing controller 120 can actuate the water valve 123 to control how much water is added to the bin 110 based on a degree of moisture within the organic materials and compost 111, that is if the organic materials and compost 111 is really dry more water is added and slightly dry less water is added.

The composting controller 120 can be further coupled to a temperature sensor 127 that is disposed within the bin 110, the temperature sensor 127 sensing a temperature within the bin 110. In at least one embodiment, the composting controller 120 can be further coupled to another sensor 129, that can be a pH sensor, a nitrogen sensor, a carbon sensor, an ammonia sensor, and/or an oxygen sensor. Such sensors allow the composting controller 120 to sense temperature, pH, nitrogen, carbon, ammonia, and/or oxygen, and make adjustments to the composting process taking place within the bin 110, accordingly. In at least one embodiment, at least one of an actuator 124, discussed in more detail below, can be activated by the compositing controller 120 when a temperature within the bin 110 falls outside of 130-170 degrees F. In at least one embodiment, the temperature sensor 127 can be disposed within the stirring arm or through a central axle thereof such that the temperature sensor 127 does not get tangled when stirred, the temperature sensor 127 remaining disposed approximately in a middle of the organic materials and compost 111.

In at least one embodiment, the composting controller 120 can include a wireless transceiver 125 (e.g., WiFi, Bluetooth, etc.) that allows the composting controller 120 to communicate, such as via the Internet, with a wireless computing device 130, such as a cell phone, a tablet computer, a smart display, a desktop computer, a laptop computer, and/or any other wireless device that can execute software to communicate with the composting controller 120. The wireless computing device 130 can remotely control operations of the composting controller 120, as described herein, and can receive and display sensor values produced by the sensors described herein. In at least one embodiment, the software executed by the wireless computing device 130 can include clear and easy to follow directions for operating the smart composting apparatus 100, in contrast to typical instructions for composting with typical composting apparatuses that are difficult, if not impossible, to follow.

The bin 110 includes an access panel 112, such as a hinged panel, that is disposed over an opening 128 within the bin 220 and to allow access to an interior 113 of the bin 110. Access to the interior 113 of the bin 110 allows the organic material 111 to be added to the interior 113 of the bin 110 and removal of the compost 111 from the bin 110. The bin 110 can be elevated off of the ground via legs 114 that are coupled to the bin 110. For example, the legs 114 are shown disposed on either sides of the bin 110, coupled centrally to ends 117a/117b of the bin 110 to allow the bin 110 to rotate about this coupling location. A user can add consumables, such as worms, nitrogen-rich materials, starter microorganisms, and/or any other consumables, to the bin 110 via the access panel 112 to assist with composting the organic materials and compost 111. Although the smart composting apparatus 100 is shown in a horizontal configuration, one skilled in the art would understand that the smart composting apparatus 100 can be turned to operate in a vertical configuration, without departing from the scope of the embodiment(s) disclosed herein, with the access panel 112 likewise being hinged relative to the orientation of the bin 110.

In at least one embodiment, a shredder and mulcher 119 can be coupled to the access panel 112. The shredder and mulcher 119 can shred/mulch whatever organic materials that are being added to the bin 110, such as banana peels, leaves, egg shells, newspaper, and/or any other organic material that a user desires to compost. The user can empty the organic material, such as from their transfer bucket discussed above from their kitchen into the shredder and mulcher 119 and it will shred/mulch this added organic material, either by button (not shown) activation or automatic activation when sensing that the organic material has been added to the shredder and mulcher 119. The shredder and mulcher 119 is made to withstand extreme outdoor temperatures and/or weather such that the shredder and mulcher 119 can be left outdoors year-round.

The bin 110 can be a rotating bin or drum. It can be beneficial to mix the organic material 111 periodically to speed the composting process. The composting controller 120 can be further coupled to the actuator 124 that, in at least one embodiment, rotates the bin 110 to mix the organic materials and compost 111 therein. The actuator 124 can include an electric motor and a stirring arm that are coupled to the bin 110, such as via a gear, that allows the actuator 124 to rotate the bin 110, even when the organic materials and compost 111 therein becomes heavy. In at least one other embodiment, instead of the actuator 124 rotating the bin 110, the actuator 124 can further include an agitator 126 disposed within the bin 110 and coupled to the actuator 124. The actuator 124, in that embodiment, rotates the agitator 126 (e.g., paddles, auger, etc.) to agitate or mix the organic materials and compost 111 within the bin 110. In at least one embodiment, the agitator 126 can be a compost crank agitator, such as that made by Lotech Products. The composting controller 120 can periodically activate the actuator 124, such as weekly. In at least one embodiment, the actuator 124 can be a combination actuator including a first type of actuator that rotates the bin 110 to mix the organic materials and compost 111 therein, and a second type of actuator that rotates the agitator 126 to mix the organic materials and compost 111. Such a combination actuator 124 can maximize mixing of the organic materials and compost 111.

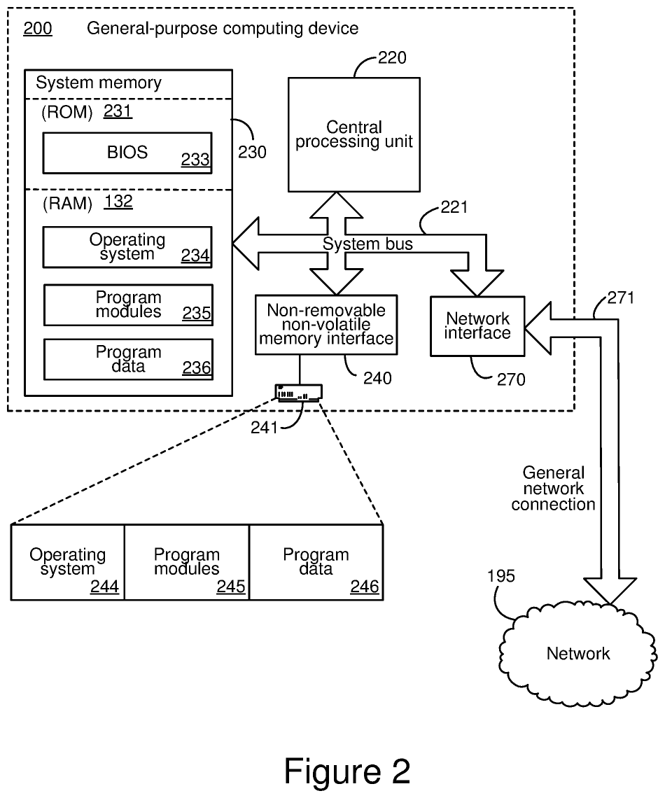

With reference to FIG. 2, an exemplary general-purpose computing device is illustrated in the form of the exemplary general-purpose computing device 200. The general-purpose computing device 200 may be of the type utilized for the composting controller 120 and/or the wireless computing device 130, as well as the other computing devices which can communicate through outside another network (not shown). As such, it will be described with the understanding that variations can be made thereto.

The exemplary general-purpose computing device 200 can include, but is not limited to, one or more central processing units (CPUs) 220, a system memory 230, such as including a Read Only Memory (ROM) 231 to store a Basic Input/Output System (BIOS) 233 and a Random Access Memory (RAM) 732, a system bus 721 that couples various system components including the system memory to the processing unit 220, a display 751, and an input device, such as a keyboard and/or mouse 752. The system bus 721 may be any of several types of bus structures including a memory bus or memory controller, a peripheral bus, and a local bus using any of a variety of bus architectures. Depending on the specific physical implementation, one or more of the CPUs 220, the system memory 230 and other components of the general-purpose computing device 200 can be physically co-located, such as on a single chip. In such a case, some or all of the system bus 721 can be nothing more than communicational pathways within a single chip structure and its illustration in FIG. 2 can be nothing more than notational convenience for the purpose of illustration.

The general-purpose computing device 200 also typically includes computer readable media, which can include any available media that can be accessed by computing device 200. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 200. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 200 may operate in a networked environment via logical connections to one or more remote computers. The logical connection depicted in FIG. 2 is a general network connection 271 to the communication network 195, which can be a local area network (LAN), a wide area network (WAN) such as the Internet, or other networks. The computing device 200 is connected to the general network connection 271 through a network interface or adapter 270, such as through wireless protocols (Bluetooth, 802.11a, ac, b, g, n, or the like), through wired (Ethernet, or the like) connections, and/or a cellular link can be provided for both voice and data (i.e., GSM, CDMA or other, utilizing 2G, 3G, and/or 4G data structures and the like). The network interface 270 is not limited to any particular protocol or type of communication. It is, however, preferred that the network interface 270 be configured to transmit data bi-directionally, through at least one mode of communication. The more robust the structure of communication, the more manners in which to avoid a failure or a sabotage with respect to communication, such as to communicate any of the messages described herein, in a timely manner, and/or through other more generic network connections, that is, in turn, connected to the system bus 721. In a networked environment, program modules depicted relative to the general-purpose computing device 200, or portions or peripherals thereof, may be stored in the memory of one or more other computing devices that are communicatively coupled to the general-purpose computing device 200 through the general network connection 271. It will be appreciated that the network connections shown are exemplary and other means of establishing a communications link between computing devices may be used.

The general-purpose computing device 200 may also include other removable/non-removable, volatile/nonvolatile computer storage media. By way of example only, FIG. 2 illustrates a hard disk drive 241 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 241 is typically connected to the system bus 721 through a non-removable memory interface such as interface 240.

The drives and their associated computer storage media discussed above and illustrated in FIG. 2, provide storage of computer readable instructions, data structures, program modules and other data for the general-purpose computing device 200. In FIG. 2, for example, hard disk drive 241 is illustrated as storing operating system 244, other program modules 245, and program data 246. Note that these components can either be the same as or different from operating system 234, other program modules 235 and program data 236. Operating system 244, other program modules 245 and program data 246 are given different numbers here to illustrate that, at a minimum, they are different copies.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A composting apparatus, comprising:
a bin to store organic materials and compost therein;
an access panel, disposed over an opening within the bin, to allow access to an interior of the bin;
an aerator, disposed within the bin, to allow air into the bin to aerate the organic materials and compost therein;
a water content sensor, disposed within the bin, to sense a quantity of water within the organic materials and compost within the bin;
a valve, coupled to a water line, to control a quantity of water added to the bin; and
a composting controller, coupled to the water content sensor and the water valve, to actuate the water valve to control a quantity of water added to the bin based on the sensed quantity of water within the organic materials and compost.

2. The composting apparatus according to claim 1, wherein the bin is a drum.

3. The composting apparatus according to claim 1, further comprising a water valve, coupled to the composing controller, to control an amount of water that is added to the bin based on the quantity of moisture sensed within the organic materials and compost.

4. The composting apparatus according to claim 1, further comprising a carbon filter to mitigate odors associated with the organic materials.

5. The composting apparatus according to claim 1, further comprising at least one other sensor, coupled to the composing controller, the at least one other sensor being at least one of a pH sensor, a nitrogen sensor, a carbon sensor, an ammonia sensor, and an oxygen sensor that sense one of pH, nitrogen, carbon, ammonia, and oxygen, respectively, the composting controller adjusting to the composting process occurring within the bin based on the sensed at least one of pH, nitrogen, carbon, ammonia, and oxygen.

6. The composting apparatus according to claim 1, further comprising a shredder and mulcher, coupled to the access penal, to shred and mulch the organic materials as the organic materials are being are being added to the bin.

7. The composting apparatus according to claim 1, further comprising legs to elevate the bin off of a ground.

8. The composting apparatus according to claim 7, wherein the legs are disposed on either sides of the bin and centrally to ends of the bin to allow the bin to rotate about where the legs are coupled to the bin.

9. The composting apparatus according to claim 1, further comprising an actuator to periodically rotate the bin to mix the organic materials and compost therein.

10. The composting apparatus according to claim 1, further comprising an agitator, disposed within the bin, coupled to an actuator, the actuator rotating the agitator to mix the organic materials and compost within the bin.

11. The composting apparatus according to claim 11, wherein the agitator is at least one of a paddle, an auger, and a compost crank aerator.

12. The composting apparatus according to claim 1, further comprising a combination actuator to periodically rotate the bin to mix the organic materials and compost within the bin and to rotate an agitator to mix the organic materials and compost within the bin.

13. The composting apparatus according to claim 1, further comprising a temperature sensor, disposed within the bin, to sense a temperature within the bin, the composting controller activating an actuator when a temperature within the bin falls outside of 130-170 degrees F.

14. The composting apparatus according to claim 1, further comprising a weight sensor to detect a weight of the organic materials and compost within the bin, with the water content sensor being a humidity sensor to detect a quantity of humidity within the bin, the composting controller formulating the water content of the organic materials and compost based on the detected humidity within the bin from the humidity sensor and based on the weight of the organic materials and compost from the weight sensor.

15. The composting apparatus according to claim 1, wherein the water content sensor is a moisture sensor to detect a quantity of moisture within the organic materials and compost.

16. The composting apparatus according to claim 15, wherein the moisture sensor is a dielectric permittivity sensor.

17. The composting apparatus according to claim 1, wherein the aerator is at least one of an aeration pipe including a plurality of holes therethrough along a length of the aeration pipe and at least one aeration vent.

18. A system including the composting apparatus according to claim 1, the system further comprising a wireless computing device to remotely control operation of the composting controller.

19. The system according to claim 18, wherein the wireless computing device includes directions for operating the smart composting apparatus.
